(19) United States
(12) Patent Application Publication
(10) Pub. No.: US 2008/0305795 A1
(43) Pub. Date: Dec. 11, 2008

(54) INFORMATION PROVISION SYSTEM

(76) Inventors: Tomoki MURAKAMI, Tokyo (JP); Hiroshi KURIHARA, Tokyo (JP); Singo MAKIMURA, Tokyo (JP); Yoshiki SHIOJI, Tokyo (JP)

Correspondence Address: NEC CORPORATION OF AMERICA, 6535 N. STATE HWY 161, IRVING, TX, 75039, US

(21) Appl. No.: 12/135,493

(22) Filed: Jun. 9, 2008

(30) Foreign Application Priority Data
Jun. 8, 2007 (JP) 2007-152250

(51) Int. Cl. H04Q 7/20

(52) U.S. Cl. 455/435.1

(57) ABSTRACT

A system includes: a user-operated terminal operated by a user holding a mobile communication terminal; and an information notification apparatus capable of communicating with the mobile communication terminal, wherein the user-operated terminal includes: spot identification information acquisition means for acquiring spot identification information; and spot registration requesting means for requesting registration of a spot by transmitting the spot identification information and user identification information identifying the user operating the user-operated terminal to the information notification apparatus, and the information notification apparatus includes: spot registration means for registering location information about the spot corresponding to the spot identification information for the user corresponding to the user identification information transmitted from the user-operated terminal; terminal location detection means for detecting the current location of the mobile communication terminal; and notification means for notifying the mobile communication terminal if the detected current location of the mobile communication terminal is within a preset distance from the location of the registered spot.

This application is based upon and claims the benefit of priority from Japanese Patent Application No. 2007-152250 filed on Jun. 8, 2007, the content of which is incorporated by reference.

### BACKGROUND OF THE INVENTION

1. Field of the Invention

The present invention relates to information provision systems, and more particularly to a system that provides information according to the location of a mobile terminal.

2. Description of the Related Art

Recently, due to popularization of mobile terminals such as mobile phones and PDAs capable of data communication, users have been able to send and receive e-mail and browse websites everywhere to easily acquire information. Such data communication functions of mobile terminals have been used to provide a push distribution service, in which various kinds of information are distributed to users from a server computer provided in a network. An exemplary use of this is to distribute predetermined information corresponding to the current location, time, and so on to a mobile terminal with a GPS function in response to the mobile terminal transmitting information about its own location to a server computer. Specifically, advertising information about shops around the user's current location can be distributed.

However, in the aforementioned push distribution service, all information corresponding to the user's current location is distributed. Therefore, information may be distributed even if the user does not want information to be provided, and many unwanted kinds of information may also be distributed. Thus, there are problems which include the inability to improve the quality of services provided to the user and the possibility that unnecessary data communications may occur.

### SUMMARY OF THE INVENTION

It is an object of the present invention to provide an information provision system capable of providing user-required information according to a user's location and improving the quality of services provided to the user.

Therefore, the present invention adopts a configuration including: a user-operated terminal operated by a user holding a mobile communication terminal; and an information notification apparatus capable of communicating with the mobile communication terminal, wherein

the user-operated terminal includes:

spot identification information acquisition means for acquiring spot identification information identifying a spot that is a predetermined place; and

spot registration requesting means for requesting registration of the spot by transmitting the acquired spot identification information and user identification information identifying the user operating the user-operated terminal to the information notification apparatus over a network, and

the information notification apparatus includes:

spot registration means for registering location information about the spot corresponding to the spot identification information for the user corresponding to the user identification information transmitted from the user-operated terminal;

terminal location detection means for detecting the current location of the mobile communication terminal; and

notification means for notifying the mobile communication terminal if the detected current location of the mobile communication terminal is within a preset distance from the location of the spot registered for the user holding the mobile communication terminal.

According to the above-described invention, the user first uses the user-operated terminal to acquire the spot identification information identifying a predetermined spot, and makes a registration request to the information notification apparatus, which then performs registration. Thereafter, the information notification apparatus detects the current location of the mobile communication terminal held by the user, and notifies the mobile communication terminal if the distance from the registered spot is not longer than the predetermined distance. Therefore, since the user can be notified when the user moves to the vicinity of the registered spot, the user can acquire necessary information in a timely manner. Since the user only has to acquire and transmit the spot identification information when registering the spot, the user can register the spot in a simple manner and improve convenience. Further, at the spot, this above described system can be convenient for users because it enables users to be notified when they are actually approaching the registered spot.

the spot can promote the user's visit because the spot allows the user to be notified when the user actually approaches the registered spot.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a block diagram showing a configuration of an information provision system in a first embodiment;

FIG. 2A is a diagram showing a display example of a two-dimensional barcode in the first embodiment;

FIG. 2B is a diagram showing a display example of the two-dimensional barcode in the first embodiment;

FIG. 3 is a diagram showing a data content example of the two-dimensional barcode in the first embodiment;

FIG. 4 is a functional block diagram showing a configuration of a mobile phone disclosed in FIG. 1;

FIG. 5 is a functional block diagram showing a configuration of a management server and a database server disclosed in FIG. 1;

FIG. 6 is an illustration diagram showing operation of the information provision system in the first embodiment;

FIG. 7 is an illustration diagram showing operation of the information provision system in the first embodiment;

FIG. 8 is an illustration diagram showing operation of the information provision system in the first embodiment;

FIG. 9 is an illustration diagram showing operation of the information provision system in the first embodiment;

FIG. 10 is a sequence diagram showing operation of the information provision system in the first embodiment;

FIG. 11 is a sequence diagram showing operation of the information provision system in the first embodiment;

FIG. 12 is a block diagram showing a configuration of the information provision system in a second embodiment;

FIG. 13 is a display screen example of the mobile phone in a variation of the second embodiment;

FIG. 14 is a block diagram showing a configuration of the information provision system in a third embodiment; and

FIG. 15 is an illustration diagram showing operation of the information provision system in a fourth embodiment.

### DETAILED DESCRIPTION OF THE PREFERRED EMBODIMENTS

An information provision system as the present invention operates in such a manner in which a user registers a spot beforehand and the system informs the user when the user approaches the vicinity of the spot.

In an aspect of the present invention, the system adopts a configuration such that the system includes: a user-operated terminal operated by a user holding a mobile communication terminal; and an information notification apparatus capable of communicating with the mobile communication terminal, wherein the user-operated terminal includes: spot identification information acquisition means for acquiring spot identification information identifying a spot that is a predetermined place; and spot registration requesting means for requesting registration of the spot by transmitting the acquired spot identification information and user identification information identifying the user operating the user-operated terminal to the information notification apparatus over a network, and the information notification apparatus includes: spot registration means for registering location information about the spot corresponding to the spot identification information for the user corresponding to the user identification information transmitted from the user-operated terminal; terminal location detection means for detecting the current location of the mobile communication terminal; and notification means for notifying the mobile communication terminal if the detected current location of the mobile communication terminal is within a preset distance from the location of the spot registered for the user holding the mobile communication terminal. The above-described user-operated terminal and mobile communication terminal may be a single terminal. That is, the mobile communication terminal may be used as the user-operated terminal to register the spot.

The system adopts a configuration such that the spot identification information acquisition means of the user-operated terminal acquires access information to the information notification apparatus along with the spot identification information, and the spot registration requesting means of the user-operated terminal requests the registration by accessing the information notification apparatus based on the access information and by transmitting the spot identification information. The system adopts a configuration such that the spot identification information acquisition means of the user-operated terminal acquires registration requesting data (data for which a registration request has been mede) such that the spot identification information is included in the access information. For example, the system adopts a configuration such that the registration requesting data is included in a two-dimensional barcode displayed to allow photographing the barcode, and the spot identification information acquisition means of the user-operated terminal acquires the registration requesting data by photographing and analyzing the two-dimensional barcode. Alternatively, the system adopts a configuration such that the registration requesting data is included in a digital broadcasting radio wave, and the spot identification information acquisition means of the user-operated terminal acquires the registration requesting data from the digital broadcasting radio wave received by the user-operated terminal.

The system adopts a configuration such that the information notification apparatus includes spot details information accumulation means in which spot details information representing details of the spot is stored, and the notification means of the information notification apparatus transmits the spot details information to the mobile communication terminal.

In addition to the above-described configurations, the system adopts a configuration such that the user-operated terminal includes registered spot information requesting means for transmitting the user identification information to the information notification apparatus and requesting registered spot information representing the spot registered for the user corresponding to the user identification information, and the information notification apparatus includes spot information provision means for transmitting the registered spot information registered for the user to the user-operated terminal in response to the request for the registered spot information from the user-operated terminal. Here, the system adopts a configuration such that the user-operated terminal includes deletion requesting means for requesting deletion of the spot with respect to the registered spot information transmitted from the information notification apparatus, and the information notification apparatus includes registered spot deletion means for deleting the location information about the spot registered for the user in response to the request to delete the spot from the user-operated terminal.

The system adopts a configuration such that the terminal location detection means of the information notification apparatus detects the current location of the mobile communication terminal by acquiring location information from a location management apparatus managing the location of the mobile communication terminal for performing call control processing for the mobile communication terminal. Further, the system adopts a configuration such that the information notification apparatus stores beforehand the location information about the spot and address information to which data for the mobile communication terminal is to be transmitted.

According to the above-described invention, the user-operated terminal operated by the user first acquires the spot identification information. For example, the user-operated terminal, as the mobile communication terminal, photographs a two-dimensional barcode appearing on a magazine, poster, television screen, or the like to acquire the spot identification information included in the two-dimensional barcode. In another example, the user-operated terminal acquires the spot identification information included in a digital broadcasting radio wave received by the user-operated terminal itself. The way the user-operated terminal acquires the spot identification information is not limited to the above. The spot includes various places such as a shop, facility, and a tourist spot.

Thereafter, the spot identification information acquired by the user-operated terminal and the user identification information identifying the user operating the terminal are transmitted to the information notification apparatus to request registration of the spot. For example, when the user finds a spot of interest to the user while browsing a magazine, television, or the like, the user uses the user-operated terminal to acquire the spot identification information from a two-dimensional barcode appearing together with the spot, or from a data broadcast transmitted together with an image of the spot, and makes a registration request to the information notification apparatus.

In response to this, the information notification apparatus registers location information about the spot corresponding to the transmitted spot identification information for the user. At this point, the location information about the spot may be included in the spot identification information, or may be stored beforehand in the information notification apparatus so that the location information about the spot corresponding to the spot identification information is read out and registered. Further, at this point, address information to which data for the user's mobile communication terminal is to be transmitted may be registered for the user. The address information may be included beforehand in the user identification information, or may be stored beforehand in the information notification apparatus.

Here, when the user-operated terminal requests information about the registered spot by transmitting the user identification information to the information notification apparatus, the information notification apparatus transmits information about the spot registered for the user to the user-operated terminal. Thus, the user can check the registered spot. When the user-operated terminal requests deletion of the registered spot based on an operation performed by the user, the information notification apparatus responds to this request to delete the spot requested to be deleted from a registration database.

Thereafter, the information notification apparatus monitors the movement of the mobile communication terminal and detects its current location. For example, the information notification apparatus detects the current location by acquiring location information from a base station apparatus managing the location of the mobile communication terminal, or by acquiring location information based on a GPS satellite acquired by the mobile communication terminal.

The information notification apparatus then determines whether or not the distance between the detected current location of the mobile communication terminal and the location information about the registered spot is not longer than a predetermined distance. If it is not longer than the predetermined distance, the information notification apparatus notifies the mobile communication terminal thereof or transmits spot details information accumulated beforehand.

Thus, according to the present invention, when the user finds a spot of interest to the user (such as a shop or facility) while browsing a magazine, poster, television, or the like, the user can first register the desired spot with a simple operation by using a two-dimensional barcode appearing on the medium such as the magazine or by using data included in a television broadcasting radio wave. Thereafter, while the user moves while holding the mobile communication terminal, the location information from the base station or GPS can be easily acquired, and the user can be notified when approaching to the registered spot. Thus, the user can acquire necessary notification when the user moves to the vicinity of the spot, and this also improve convenience because the spot can be registered in a simple manner. Further, at the spot, the above described system can be convenient for users because it enables users to be notified when they are actually approaching the spot in which they have taken an interest and which they have registered.

An information notification apparatus as another aspect of the present invention adopts a configuration such that the information notification apparatus is connected over a network to a user-operated terminal operated by a user holding a mobile communication terminal and is capable of communicating with the mobile communication terminal, wherein the information notification apparatus includes: spot registration request reception means for receiving a spot registration request from the user-operated terminal by receiving, from the user-operated terminal, spot identification information identifying a spot that is a predetermined place acquired by the user-operated terminal and by user identification information identifying the user operating the user-operated terminal; spot registration means for registering location information about the spot corresponding to the spot identification information for the user corresponding to the user identification information; terminal location detection means for detecting the current location of the mobile communication terminal; and notification means for notifying the mobile communication terminal if the detected current location of the mobile communication terminal is within a preset distance from the location of the spot registered for the user holding the mobile communication terminal.

A program as another aspect of the present invention adopts a configuration such that the program causes an information notification apparatus that is connected over a network to a user-operated terminal operated by a user holding a mobile communication terminal and that is capable of communicating with the mobile communication terminal to implement: a spot registration request reception function for receiving a spot registration request from the user-operated terminal by receiving, from the user-operated terminal, spot identification information identifying a spot that is a predetermined place acquired by the user-operated terminal and user identification information identifying the user operating the user-operated terminal; a spot registration function for registering location information about the spot corresponding to the spot identification information for the user corresponding to the user identification information; a terminal location detection function for detecting the current location of the mobile communication terminal; and a notification function for notifying the mobile communication terminal if the detected current location of the mobile communication terminal is within a preset distance from the location of the spot registered for the user holding the mobile communication terminal.

Further, an information provision method as another aspect of the present invention adopts a configuration such that the method is an information notification method for a system including: a user-operated terminal operated by a user holding a mobile communication terminal; and an information notification apparatus capable of communicating with the mobile communication terminal, wherein the method includes: a spot identification information acquisition step in which the user-operated terminal acquires spot identification information identifying a spot that is a predetermined place; a spot registration requesting step in which the user-operated terminal requests registration of the spot by transmitting the acquired spot identification information and user identification information identifying the user operating the user-operated terminal to the information notification apparatus over a network; a spot registration step in which the information notification apparatus registers location information about the spot corresponding to the spot identification information for the user corresponding to the user identification information transmitted from the user-operated terminal; a terminal location detection step in which the information notification apparatus detects the current location of the mobile communication terminal; and a notification step in which the information notification apparatus notifies the mobile communication terminal if the detected current location of the mobile communication terminal is within a preset distance from the location of the spot registered for the user holding the mobile communication terminal.

Now, specific configurations of the information provision system, information notification apparatus, program, and information provision method configured as described above will be described in exemplary embodiments.

### First Embodiment

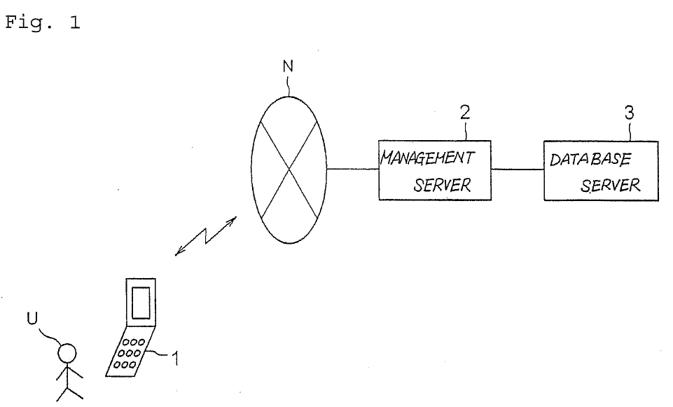

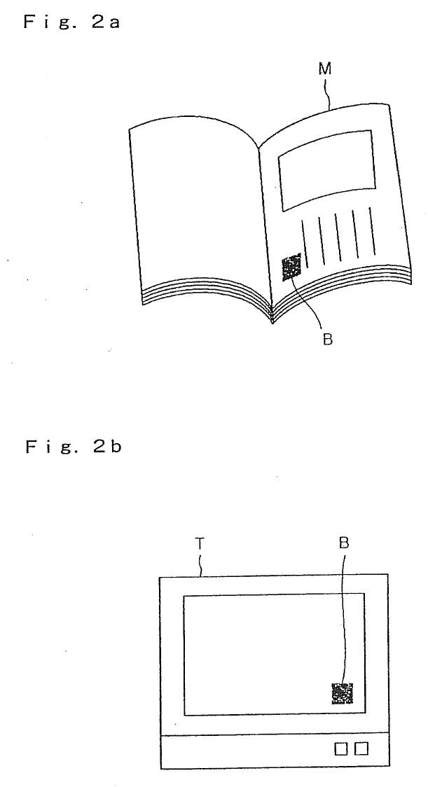

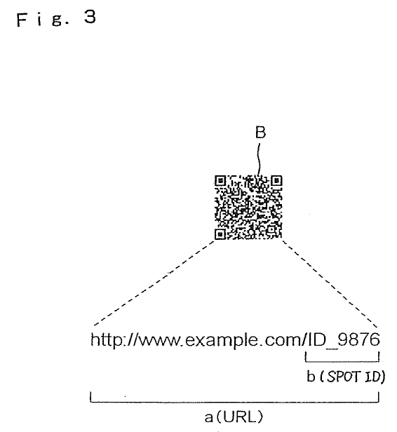

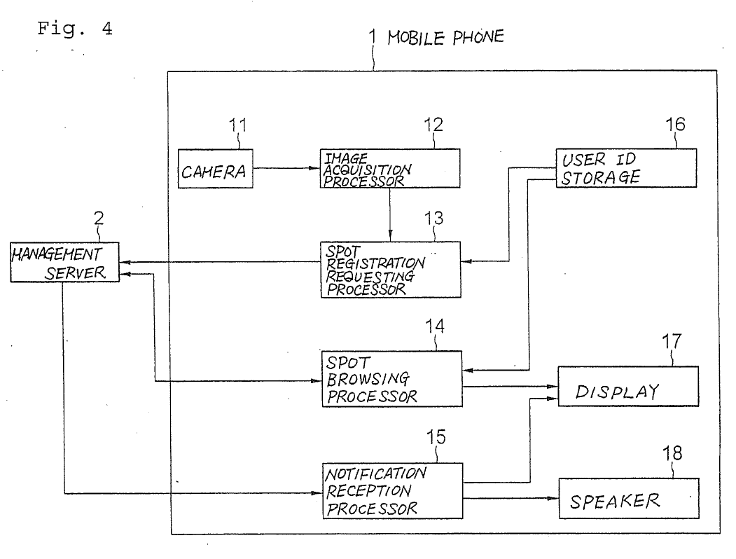

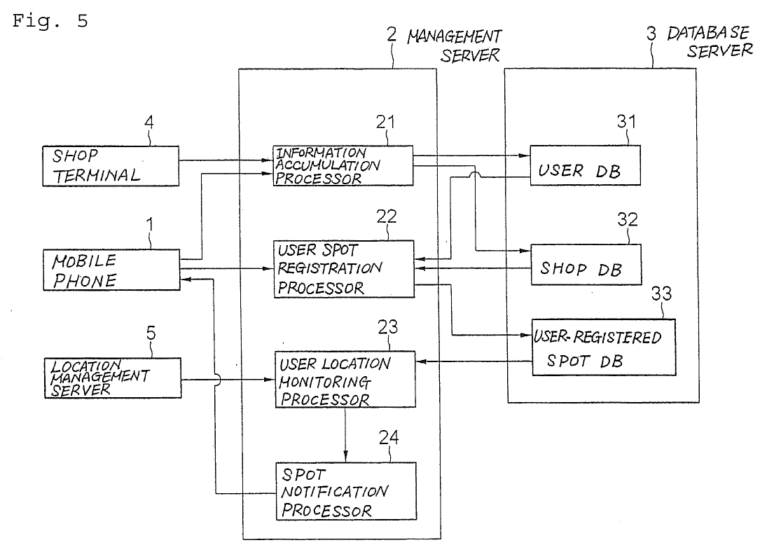

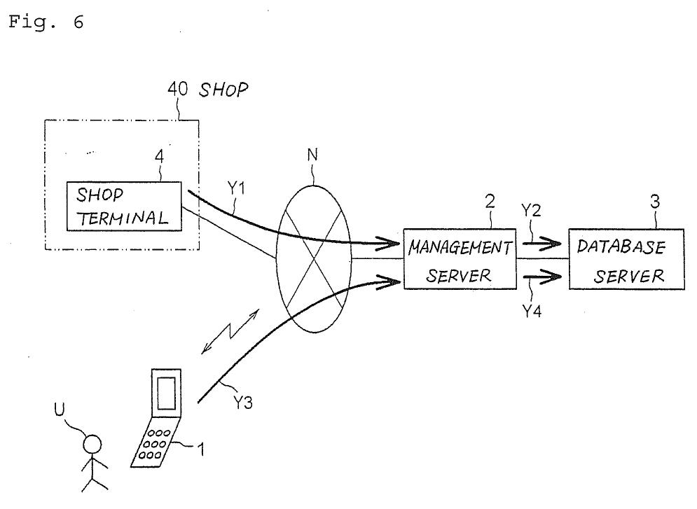

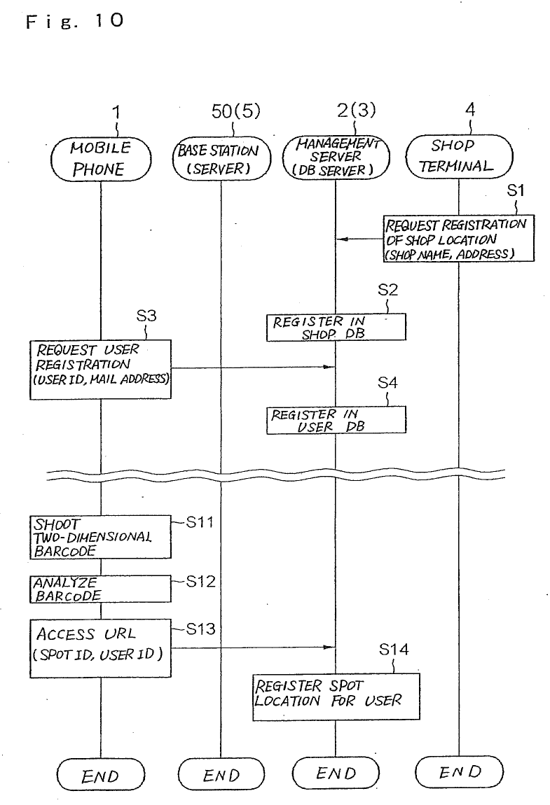

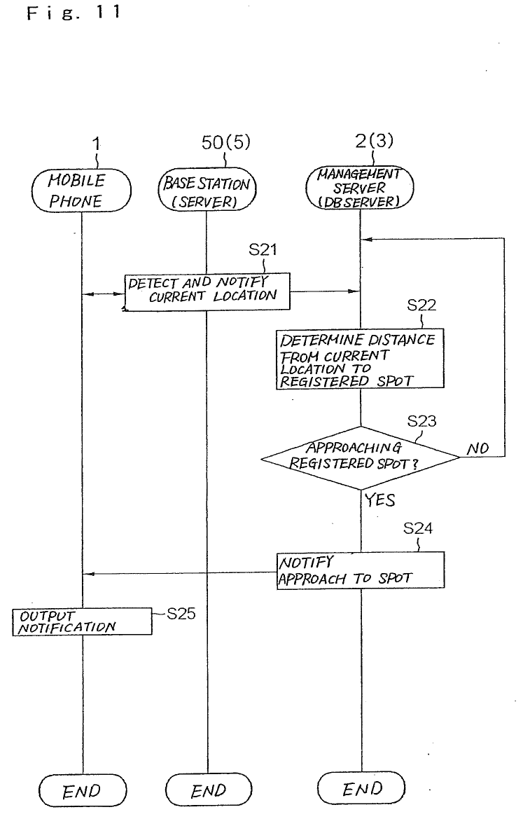

A first exemplary embodiment will be described with reference to FIGS. 1 to 11. FIG. 1 is a block diagram showing an overall configuration of the information provision system. FIGS. 2A to 3 are diagrams for describing a two-dimensional barcode in which spot information is stored. FIG. 4 is a functional block diagram showing a configuration of a mobile phone, and FIG. 5 is a functional block diagram showing a configuration of a management server and a database server. FIGS. 6 to 9 are illustration diagrams showing operation of the system, and FIGS. 10 and 11 are sequence diagrams.

While an exemplary spot will be described as a shop in the following description, the spot is not limited to a shop but may be any places like constructions such as buildings and facilities, sites such as tourist spots, and so on.

### [Configuration]

As shown in FIG. 1, the information provision system according to this exemplary embodiment includes mobile phone 1 held by user U, management server 2 connected to this mobile phone 1 over network N, and database server 3. Mobile phone 1 is a mobile communication terminal carried about with user U, and also functions as a user-operated terminal operated when performing spot registration, as will be described later. That is, in this exemplary embodiment, description will be given for the case where the aforementioned mobile communication terminal and user-operated terminal are implemented as single mobile phone 1. However, as will be described later in other exemplary embodiments, the mobile communication terminal and the user-operated terminal may be implemented as separate terminals. Now, each configuration will be described below.

First, a two-dimensional barcode that can be photographed by mobile phone 1 that includes a camera function will be described. FIG. 2A shows a certain page of magazine M, on which two-dimensional barcode B is printed. This page contains an article about a certain shop (spot), for example, and two-dimensional barcode B on the same page includes information (spot identification information) identifying the shop (spot).

FIG. 3 shows a specific example of two-dimensional barcode B. Two-dimensional barcode B shown includes information “http://www.example.com/ID_{—}9876” as indicated thereunder. In this information, the entire portion a “http://www.example.com/ID_{—}9876” is a URL (access information) representing an access address to a spot registration website (to be described later) managed by management server 2. The latter portion b “ID_{—}9876” is a spot ID, which is information identifying the shop (spot) that appears on the same page with two-dimensional barcode B. Thus, as will be described later, when mobile phone 1 takes a photo of two dimensional barcode B and reads the information in the barcode, management server 2 can be accessed and notified of the spot ID.

The above-described two-dimensional barcode B that can be photographed by mobile phone 1 is not limited to the one appearing in magazine M. For example, as shown in FIG. 2B, it may be displayed on a television broadcast screen. In this case, for example, during a commercial of a shop, two-dimensional barcode B that has a URL including a spot ID identifying the shop is displayed. The barcode may also be displayed on posters and websites.

Next, a configuration of mobile phone 1 will be described with reference to FIG. 4. As shown in FIG. 4, mobile phone 1 in this exemplary embodiment is equipped with camera 11 and is capable of shooting images. A predetermined program is incorporated in a CPU of mobile phone 1 to drive image acquisition processor 12, spot registration requesting processor 13, spot browsing processor 14, and notification reception processor 15. User ID storage 16 is formed from a memory cell of mobile phone 1. Of course, mobile phone 1 includes the functions of a general mobile phone, such as display 17 as a screen display, speaker 18 that outputs sounds such as a ringtone, and operation buttons (not shown).

Image acquisition processor 12 includes a function of taking a photo of two-dimensional barcode B with camera 11 and reading information (registration requesting data) included in barcode B (spot identification information acquisition means). Spot registration requesting processor 13 includes a function of accessing the spot registration website managed by management server 2 based on the information read from two-dimensional barcode B, i.e., the URL shown in FIG. 3, and requesting registration of a spot (spot registration requesting means). At this point, since the URL includes the spot ID, management server 2 is notified of the spot ID. This is equivalent to requesting registration of a shop corresponding to the spot ID. Further, when accessing the spot registration website, information that identifies user U (user identification information) stored in user ID storage 16, for example a phone number that is information unique to mobile phone 1, is read and provided to the URL target. In response to this, management server 2 registers the spot for the user as will be described later. The information that identifies user U is not limited to a phone number. Any information may be used as long as it is unique to user U.

Although not shown, mobile phone 1 includes a function of preliminarily accessing management server 2 and performing user registration. In this case, a contact address allowing communication with this mobile phone 1, for example an e-mail address (address information), is transmitted to management server 2 along with the above-described information that identifies user U. The mail address is registered in management server 2 together with the user identification information. At this point, if the user identification information is a phone number, the number may be used as the address to which data is to be transmitted from management server 2.

Spot browsing processor 14 includes a function of requesting browsing of a list of the user's spots registered in management server 2 (registered spot information requesting means). At this point, spot browsing processor 14 reads the user identification information stored in user ID storage 16 and notifies management server 2 of the user identification information. In response to this request, management server 2 identifies user U based on the received user identification information and transmits a list of spots registered for this user to the mobile phone. Thus, mobile phone 1 displays the transmitted spot list on display 17, and user U can check the registered spots. Spot browsing processor 14 also includes a function of, when an instruction to delete a registered spot of user U is input from user U, notifying management server 2 of the spot identification information and the deletion instruction (deletion requesting means). Management server 2 then deregisters the spot to be deleted.

Notification reception processor 15 provides information corresponding to the location of mobile phone 1 (notification means), while management server 2 is monitoring the location of mobile phone 1 as will be described later. Specifically, as described above, when mobile phone 1 approaches a spot registered in management server 2, notification reception processor 15 is notified thereof by management server 2. Then, notification reception processor 15 has a function of providing a notification of the user's approach to the registered spot by displaying the notification on display 17 or by a sound output from the speaker.

Next, a configuration of management server 2 and database server 3 will be described. Database server 3 may be built in a storage device incorporated in management server 2. That is, management server 2 and database server 3 may be implemented as a single computer. However, management server 2 may be implemented as a plurality of computers.

Management server 2 is a general server computer and, as described above, manages the spot registration website on which each user U can register spots. A predetermined program is incorporated in a CPU of management server 2 to drive information accumulation processor 21, user spot registration processor 22, user location monitoring processor 23, and spot notification processor 24. User DB 31, shop DB 32, and user-registered spot DB 33 are formed in database server 3.

Aforementioned information accumulation processor 21 includes a function of receiving a shop name and location information (such as the address) and registering them in shop DB 32 when shop registration is requested by a shop beforehand. Similarly, information accumulation processor 21 includes a function of receiving a user ID and mail address of user U and registering them in user DB 31 when registration for use is requested by user U beforehand.

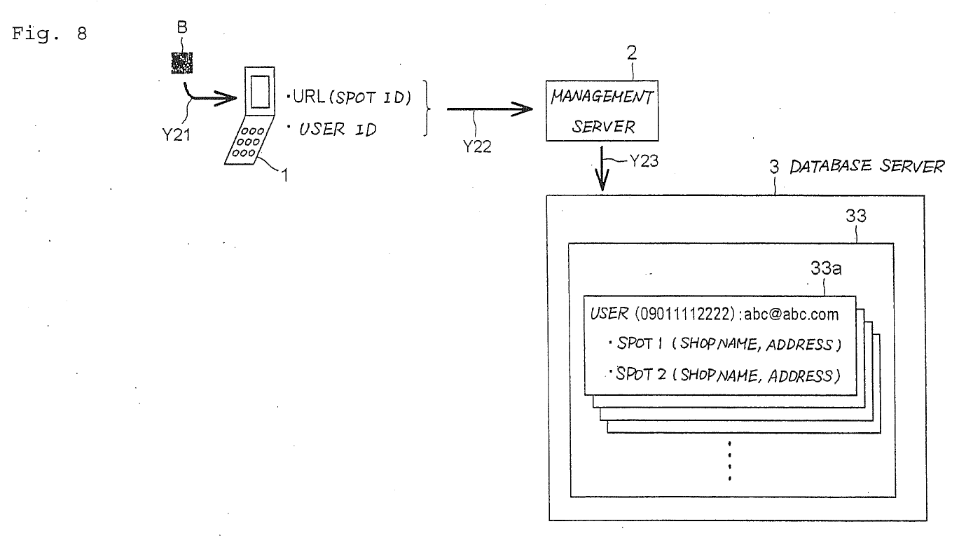

User spot registration processor 22 (spot registration request reception means, spot registration means) includes a function of receiving a spot registration request from mobile phone 1 and registering a spot for the user in user-registered spot DB 33 in database server 3 as described above. Specifically, a mail address corresponding to a user ID transmitted from mobile phone 1 upon request of spot registration is read from user DB 31 in which the mail address has been registered beforehand. The shop name and location information about a spot corresponding to a transmitted spot ID are also read from shop DB 32. Then, the user's user ID and mail address, and the shop name and location information about the spot, are registered in association with each other. In this manner, a list of spots registered for each user (see symbol 33a) is generated and registered as shown in FIG. 8 to be described later.

User spot registration processor 22 also includes a function of transmitting, in response to a spot browsing request from mobile phone 1 as described above, information about registered spots, for example the shop names and location information about the spots, to mobile phone 1 to allow display of the information (spot information provision means). That is, in response to the spot browsing request from user U, user U is identified from the user ID transmitted from mobile phone 1. A management page for the registered spots of this user U is generated, and a list of the registered spots is transmitted to mobile phone 1 for display on mobile phone 1. Further, when user U selects a certain spot on this management page through mobile phone 1 and requests deletion of the spot, user spot registration processor 22 operates to delete the location information about the spot registered for user U from the list and for which a request to be deleted has been made.

For mobile phone 1 for which spots have been registered, user location monitoring processor 23 constantly detects the current location of mobile phone 1 (terminal location detection means). In this exemplary embodiment, location information managed in location management server 5 (a location management apparatus) by base station 50 which is in constant communication with mobile phone 1 is acquired to detect a rough current location of mobile phone 1. Specifically, in order to efficiently perform call control processing for mobile phone 1, mobile phone 1 and base station 50 are in constant communication with each other to perform processing for determining a base station area where mobile phone 1 exists and for registering the location. This location registration information essential to mobile phone 1 is used to monitor the current location. User location monitoring processor 23 computes the distance between the current location of mobile phone 1 and the location information about a spot registered for the user holding this mobile phone 1, and determines whether or not mobile phone 1 is located within a preset distance from the registered spot. If mobile phone 1 is located within the preset distance, user location monitoring processor 23 provides the user's mail address to spot notification processor 24.

Spot notification processor 24 (notification means) transmits, to the mail address provided from user location monitoring processor 23, data notifying that mobile phone 1 is approaching the registered spot. For example, the shop name and address of the registered spot approached within the preset distance are transmitted. Thus, user U can recognize that user U is approaching the registered spot based on an alarm such as a ringtone upon receiving mail in mobile phone 1, and can view display of the shop name and so on of the registered spot as an e-mail message.

### [Operation]

Now, operation of the information provision system in the above configuration will be described. First, operation up to the spot registration performed by user U will be described with reference to operation illustration diagrams in FIGS. 6 to 8 and a sequence diagram in FIG. 10.

Shop 40 desiring to have its shop registered as a spot by user U uses shop terminal 4 connected to network N to access management server 2 and to perform shop registration. At this point, shop terminal 4 requests registration by transmitting the shop name and address (arrow Y1 in FIG. 6, step 1 in FIG. 10). Management server 2 assigns a spot ID to the shop and registers the shop name and address in shop DB 32 in association with the spot ID (arrow Y2 in FIG. 6, step 2 in FIG. 10). This spot ID is data unique to each shop, and shop 40 is notified of the spot ID.

Although not shown, shop 40 generates two-dimensional barcode B including the spot ID assigned thereto and the URL and provides them to the above-described spot registration website managed by management server 2. Shop 40 arranges that generated two-dimensional barcode B is shown in a magazine together with an advertisement or is displayed in a television commercial of its shop. The two-dimensional barcode may be generated on the side of management server 2 at the time of the above-described shop registration and provided to the shop.

When user U desires to use a service of receiving a notification of approaching registered spots, user U accesses management server 2 beforehand from mobile phone 1 that is used to receive the notification, and performs user registration. At this point, mobile phone 1 requests registration by transmitting a mail address input by user U, along with a user ID such as a phone number that is automatically transmitted from mobile phone 1 (arrow Y3 in FIG. 6, step 3 in FIG. 10). Management server 2 registers the user ID and the mail address in association with each other (arrow Y4 in FIG. 6, step 4 in FIG. 10). Thus, advance preparation for the spot registration is completed.

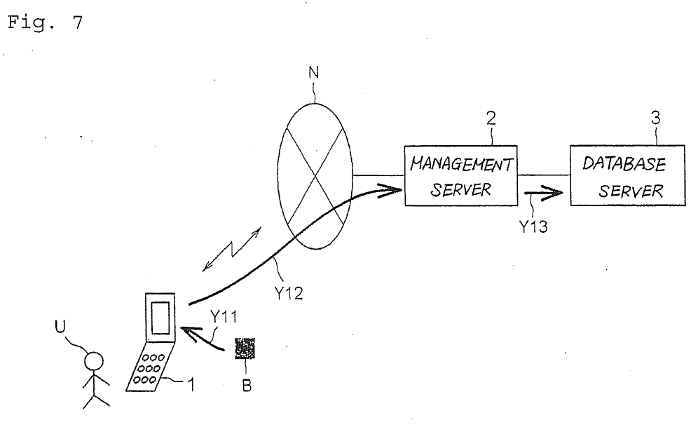

Thereafter, when user U finds a shop of interest to user U while reading a magazine, user U uses the camera function of mobile phone 1 to photograph two-dimensional barcode B displayed together with information about the shop (arrow Y11 in FIG. 7, arrow 21 in FIG. 8, step 11 in FIG. 10, spot identification information acquisition step). Mobile phone 1 analyzes the content of acquired two-dimensional barcode B (step 12 in FIG. 10) and reads out a URL included therein. The read-out URL is the address to the spot registration website of management server 2 as described above, and includes the spot ID that identifies this shop. User U accesses this URL with mobile phone 1 (arrow Y12 in FIG. 7, arrow Y22 in FIG. 8, step 13 in FIG. 10). At this point, as mobile phone 1 accesses the URL, mobile phone 1 notifies management server 2 of the spot ID included in the URL and also the user ID such as a phone number, thereby requesting registration of the spot that corresponds to the spot ID (spot registration requesting step).

Upon receiving the spot registration request from mobile phone 1, management server 2 reads out the mail address of user U corresponding to the user ID from user DB 31 and also reads out the shop name and address of the spot corresponding to the spot ID from shop DB 32. Management server 2 registers them in user-registered spot DB 33 in association with each other (arrow Y13 in FIG. 7, arrow Y23 in FIG. 8, step 14 in FIG. 10, spot registration step).

When user U wants to check the user's registered spots, user U makes a request from mobile phone 1 to management server 2. Management server 2 transmits a registered-spot list for this user U to mobile phone 1. Thus, user U can browse and check the registered spots. At this point, if user U selects a no more needed spot displayed on mobile phone 1 and requests management server 2 to delete the spot, management server 2 deletes the spot, for which a request to be deleted has been made from the list. This allows organizing the registered spots.

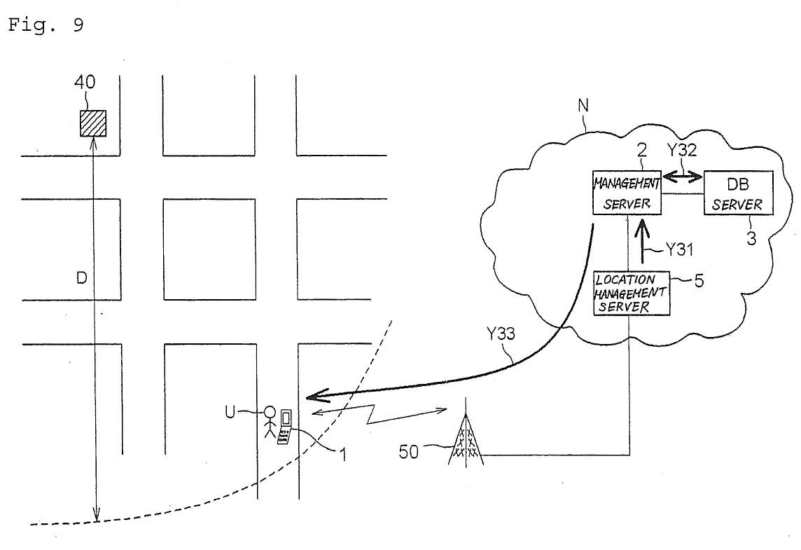

Next, an operation of notifying user U of a registered spot will be described with reference to an operation illustration diagram in FIG. 9 and a sequence diagram in FIG. 11. Base station 50 is in constant communication with mobile phone 1 to register the location of mobile phone 1 in location management server 5. Management server 2 acquires the location registration information about mobile phone 1 from location management server 5 and detects the current location of mobile phone 1 (arrow Y31 in FIG. 9, step 21 in FIG. 11, terminal location detection step). At this point, management server 2 also acquires the user ID such as a phone number unique to mobile phone 1 whose current location has been detected.

Management server 2 checks the distance between the detected current location of mobile phone 1 and the location information about a registered spot for the user that can be identified from the phone number of mobile phone 1 (arrow Y32 in FIG. 9, step 22 in FIG. 11). If the distance between the current location of mobile phone 1 and the location of the registered spot (shop 40) is not longer than preset distance D (see FIG. 9, YES in step 23 in FIG. 11), the mail address of mobile phone 1 is read out to transmit mail that provides notification of the shop name and address of the spot (arrow Y33 in FIG. 9, step 24 in FIG. 11, notification step). Mobile phone 1 is given a mail arrival alarm, and the shop name and so on of the spot are displayed on the screen display. This allows user U to recognize the proximity to the spot.

Thus, according to the system in this exemplary embodiment, when the user finds a spot of interest to the user (such as a shop or facility) while browsing a magazine, poster, or television, the user can first use the two-dimensional barcode that appears on the medium, such as a magazine, to register the desired spot with a simple operation. Thereafter, while user U moves with mobile phone 1, the current location can be easily detected from the location information acquired by the base station, and user U can be notified of the proximity to the registered spot. Thus, the user can be notified of the proximity to the required spot, and convenience for the user is also improved because a simple operation for registering the spot can be achieved. Further, at the spot, the above described system can be convenient for users because it enables users to be notified when they are actually approaching the spot in which they have taken an interest and which they have registered.

### Second Embodiment

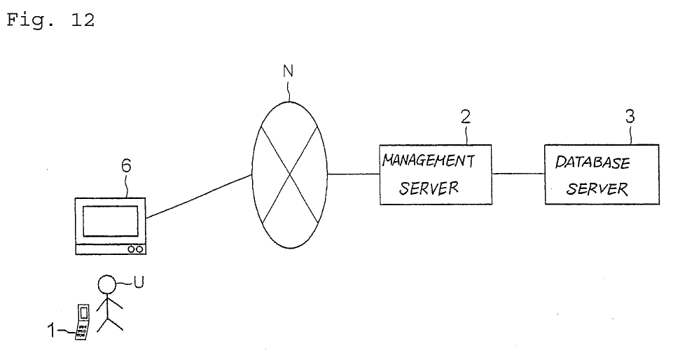

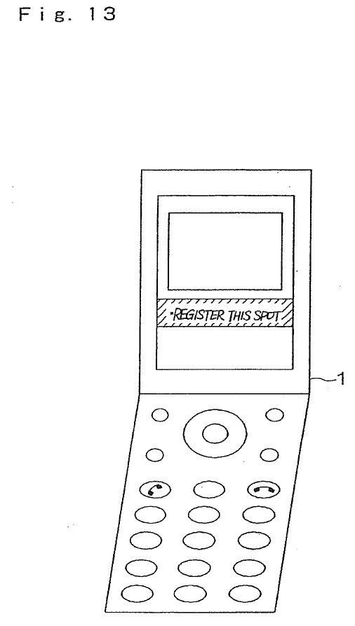

Now, a second exemplary embodiment will be described with reference to FIGS. 12 and 13. FIG. 12 is a block diagram showing a general configuration of the information provision system. FIG. 13 is a diagram showing a display screen example of the mobile phone in another example of this exemplary embodiment.

The information provision system in this exemplary embodiment basically adopts the same configuration as the system disclosed in the first embodiment. However, a terminal used for the spot registration exists separately from the mobile phone, and the spot ID that in necessary for registration is acquired in a different manner.

Specifically, as shown in FIG. 12, the system includes television terminal 6 (user-operated terminal) connected to network N and operated by user U. This television terminal 6 supports digital broadcasting and can acquire data included in a digital broadcasting radio wave. Television terminal 6 can also transmit data to a broadcast station or network N.

In this exemplary embodiment, the digital broadcasting radio wave includes registration requesting data including the same URL as the one in the above-described two-dimensional barcode, i.e., a URL including a spot ID. Specifically, a URL linked to management server 2 including a spot ID identifying a shop (spot) corresponding to a program or a commercial being broadcasted is transmitted as a data broadcast, and television terminal 6 can receive this URL (spot identification information acquisition means). Further, when user U selects this URL and inputs a registration request instruction, television terminal 6 can request management server 2 to register the spot corresponding to the spot ID included in the URL. At this point, television terminal 6 transmits a user ID that identifies user U (e.g., a phone number of mobile phone 1 held by this user U) to management server 2 along with the registration request. Thus, management server 2 can identify user U, i.e., mobile phone 1 for which the location is to be monitored and a mail notification is to be sent, and can identify the spot to be registered. Management server 2 can register them in association with each other.

Management server 2 monitors the current location of mobile phone 1 of user U for which the spot has been registered, and notifies user U by e-mail when user U approaches the registered spot. This processing is the same as in the first embodiment and therefore will not be described.

A variation of this exemplary embodiment will be described with reference to FIG. 13. Mobile phone 1 shown in FIG. 13 is capable of receiving a digital broadcasting radio wave and allows browsing television images of what is called one-segment broadcasting. Therefore, like television terminal 6 disclosed in above-described FIG. 12, mobile phone 1 can receive a URL link to management server 2 including a spot ID that identifies a shop (spot) corresponding to a program or a commercial transmitted as a data broadcast along with television image data on the digital broadcasting radio wave (spot identification information acquisition means).

Mobile phone 1 can then select “Register this spot” transmitted by the data broadcast and displayed on the screen, as shown in FIG. 13. Mobile phone 1 can thereby acquire the URL included in the data broadcast and access this URL to request management server 2 to register the spot corresponding to the spot ID included in the URL. At this point, mobile phone 1 transmits a user ID (such as a phone number) to management server 2 along with the registration request. Thus, management server 2 can identify the user, i.e., mobile phone 1 for which the location is to be monitored and a mail notification is to be sent, and can identify the spot to be registered. Management server 2 can register them in association with each other.

Management server 2 monitors the current location of mobile phone 1 of user U for which the spot has been registered, and notifies user U by e-mail when user U approaches the registered spot. This processing is the same as in the first embodiment and therefore will not be described.

### Third Embodiment

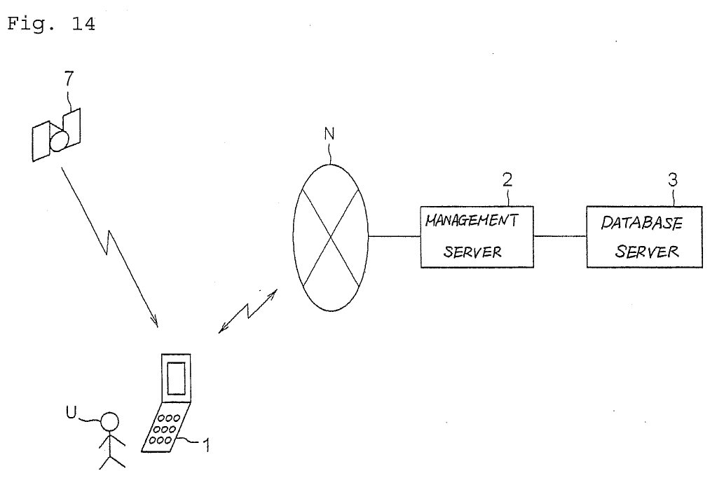

Now, a third exemplary embodiment will be described with reference to FIG. 14. FIG. 14 is a block diagram showing a general configuration of the information provision system.

The information provision system in this exemplary embodiment basically adopts the same configuration as the system disclosed in the first embodiment. However, what is different is that the current location information about mobile phone 1 detected by management server 2 is acquired by using location information obtained by mobile phone 1 from GPS satellite 7, rather than acquired from base station 50 and location management server 5.

Specifically, mobile phone 1 in this exemplary embodiment is equipped with a GPS antenna. Mobile phone 1 acquires location information from GPS satellite 7 according to an operation performed by user U and transmits this location information to management server 2 at predetermined intervals as information representing the current location of mobile phone 1. Management server 2, based on the received location information, determines whether or not mobile phone 1 is located near a registered spot and transmits notification of this as described above.

### Fourth Embodiment

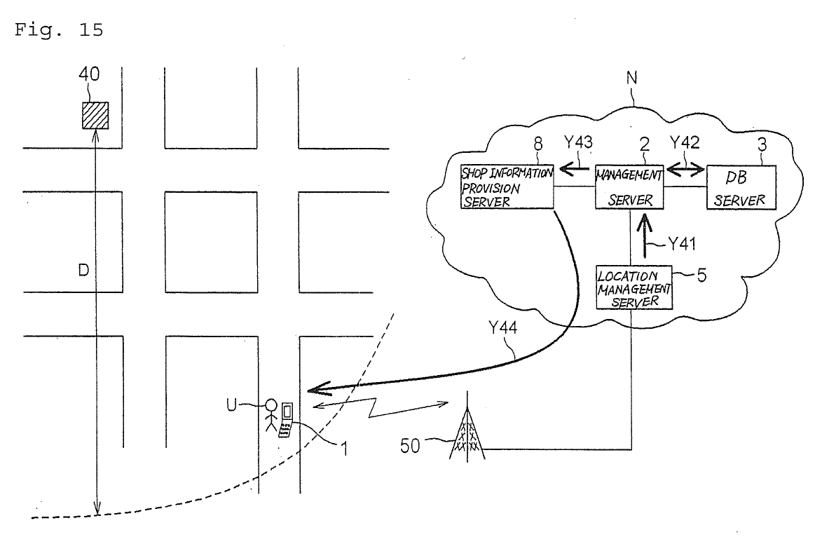

Now, a fourth exemplary embodiment will be described with reference to FIG. 15. FIG. 15 is a block diagram showing a general configuration and operation of the information provision system.

The information provision system in this exemplary embodiment basically adopts the same configuration as the system disclosed in the first embodiment. However, when notifying mobile phone 1 of the user's proximity to a registered spot, the information provision system is configured to transmit not only the notification thereof but also information about the spot to mobile phone 1.

Specifically, as shown in FIG. 15, connected to network N is shop information provision server 8 (spot details information accumulation means) in which shop details information (spot details information) such as information introducing the characteristics of shops and product line information are accumulated. For example, this shop information provision server 8 may be an existing web server that manages a website that provide shop information.

Management server 2 monitors the current location of mobile phone 1 as described above (arrow Y41 in FIG. 15). If it is determined that the detected current location of mobile phone 1 is approaching the location of a registered spot (arrow Y42 in FIG. 15), management server 2 provides the mail address of recipient mobile phone 1 to shop information provision server 8 and requests the server to transmit the shop details information (arrow Y43 in FIG. 15). In response to this request, shop information provision server 8 transmits the shop details information to the mail address of mobile phone 1 provided from management server 2 (arrow Y44 in FIG. 15).

The aforementioned shop details information may be accumulated in any server and may be transmitted to mobile phone 1 from any computer. For example, management server 2 may transmit the shop details information.

The present invention can be utilized when a communication carrier that manages the location of mobile phones implements an information provision service in connection with location, and therefore has an industrial applicability.

While a preferred embodiment of the present invention has been described using specific terms, such description is for illustrative purposed only, and it is to be understood that changes and variations may be made without departing from the sprit or scope of the following claims.

What is claimed is:

1. An information provision system comprising: a user-operated terminal operated by a user holding a mobile communication terminal; and an information notification apparatus capable of communicating with the mobile communication terminal, wherein
the user-operated terminal comprises:
spot identification information acquisition means for acquiring spot identification information identifying a spot that is a predetermined place; and
spot registration requesting means for requesting registration of the spot by transmitting the acquired spot identification information and user identification information identifying the user operating the user-operated terminal to the information notification apparatus over a network, and
the information notification apparatus comprises:
spot registration means for registering location information about the spot corresponding to the spot identification information for the user corresponding to the user identification information transmitted from the user-operated terminal;
terminal location detection means for detecting the current location of the mobile communication terminal; and
notification means for notifying the mobile communication terminal if the detected current location of the mobile communication terminal is within a preset distance from the location of the spot registered for the user holding the mobile communication terminal.

2. The information provision system according to claim 1, wherein
the spot identification information acquisition means acquires access information to the information notification apparatus along with the spot identification information, and
the spot registration requesting means requests the registration by accessing the information notification apparatus based on the access information and by transmitting the spot identification information.

3. The information provision system according to claim 2, wherein
the spot identification information acquisition means acquires registration requesting data such that the spot identification information is included in the access information.

4. The information provision system according to claim 3, wherein
the registration requesting data is included in a two-dimensional barcode displayed to allow photographing the barcode, and
the spot identification information acquisition means acquires the registration requesting data by photographing and analyzing the two-dimensional barcode.

5. The information provision system according to claim 3, wherein
the registration requesting data is included in a digital broadcasting radio wave, and
the spot identification information acquisition means acquires the registration requesting data from the digital broadcasting radio wave received by the user-operated terminal.

6. The information provision system according to claim 1, wherein
the information notification apparatus comprises spot details information accumulation means in which spot details information representing details of the spot is stored, and
the notification means transmits the spot details information to the mobile communication terminal.

7. The information provision system according to claim 1, wherein
the user-operated terminal comprises registered spot information requesting means for transmitting the user identification information to the information notification apparatus and requesting registered spot information representing the spot registered for the user corresponding to the user identification information, and
the information notification apparatus comprises spot information provision means for transmitting the registered spot information registered for the user to the user-operated terminal in response to the request for the registered spot information from the user-operated terminal.

8. The information provision system according to claim 1, wherein
the user-operated terminal comprises deletion requesting means for requesting deletion of the spot with respect to the registered spot information transmitted from the information notification apparatus, and
the information notification apparatus comprises registered spot deletion means for deleting the location information about the spot registered for the user in response to the request to delete the spot from the user-operated terminal.

9. The information provision system according to claim 1, wherein
the terminal location detection means detects the current location of the mobile communication terminal by acquiring location information from a location management apparatus managing the location of the mobile communication terminal for performing call control processing for the mobile communication terminal.

10. The information provision system according to claim 1, wherein
the information notification apparatus stores beforehand the location information about the spot and address information to which data for the mobile communication terminal is to be transmitted.

11. The information provision system according to claim 1, wherein
the user-operated terminal is the mobile communication terminal.

12. An information notification apparatus that is connected over a network to a user-operated terminal operated by a user holding a mobile communication terminal and that is capable of communicating with the mobile communication terminal, comprising:
spot registration request reception means for receiving a spot registration request from the user-operated terminal by receiving, from the user-operated terminal, spot identification information identifying a spot that is a predetermined place acquired by the user-operated terminal and user identification information identifying the user operating the user-operated terminal;
spot registration means for registering location information about the spot corresponding to the spot identification information for the user corresponding to the user identification information;
terminal location detection means for detecting the current location of the mobile communication terminal; and
notification means for notifying the mobile communication terminal if the detected current location of the mobile communication terminal is within a preset distance from the location of the spot registered for the user holding the mobile communication terminal.

13. A program for causing an information notification apparatus that is connected over a network to a user-operated terminal operated by a user holding a mobile communication terminal and that is capable of communicating with the mobile communication terminal to implement:
a spot registration request reception function for receiving a spot registration request from the user-operated terminal by receiving, from the user-operated terminal, spot identification information identifying a spot that is a predetermined place acquired by the user-operated terminal and user identification information identifying the user operating the user-operated terminal;
a spot registration function for registering location information about the spot corresponding to the spot identification information for the user corresponding to the user identification information;
a terminal location detection function for detecting the current location of the mobile communication terminal; and
a notification function for notifying the mobile communication terminal if the detected current location of the mobile communication terminal is within a preset distance from the location of the spot registered for the user holding the mobile communication terminal.

14. An information notification method for a system comprising: a user-operated terminal operated by a user holding a mobile communication terminal; and an information notification apparatus capable of communicating with the mobile communication terminal, the method comprising:
spot identification information acquisition in which the user-operated terminal acquires spot identification information identifying a spot that is a predetermined place;
spot registration requesting in which the user-operated terminal requests registration of the spot by transmitting the acquired spot identification information and user identification information identifying the user operating the user-operated terminal to the information notification apparatus over a network;
spot registration in which the information notification apparatus registers location information about the spot corresponding to the spot identification information for the user corresponding to the user identification information transmitted from the user-operated terminal;
terminal location detection in which the information notification apparatus detects the current location of the mobile communication terminal; and
notification in which the information notification apparatus notifies the mobile communication terminal if the detected current location of the mobile communication terminal is within a preset distance from the location of the spot registered for the user holding the mobile communication terminal.
